(19) United States
(12) Patent Application Publication
(10) Pub. No.: US 2004/0051380 A1
(43) Pub. Date: Mar. 18, 2004

(54) Anti-theft device for vehicle

(75) Inventor: Tohru Okada, Aichi-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN ENGINEERING CO., LTD., Kariya (JP)

(21) Appl. No.: 10/616,311

(22) Filed: Jul. 10, 2003

(30) Foreign Application Priority Data
Jul. 10, 2002 (JP) 2002-236729

(51) Int. Cl. B60R 25/04

(52) U.S. Cl. 307/10.5

(57) ABSTRACT

An anti-theft device for a vehicle includes a code including the unique information and a reference code memorized in a vehicle. The start of an engine is allowed when the unique code is identified with the reference code. The unique code is provided on an ignition key and the unique code includes portions including different reflective ratios when a light is irradiated.

This application is based on and claims priority under 35 U.S.C. §119 with respect to Japanese Patent Application No. 2002-236729, filed on Jul. 10, 2002, the entire contents of which are incorporated herein by reference.

### FIELD OF THE INVENTION

The present invention relates to an anti-theft device for a vehicle. More particularly, the present invention pertains to an anti-theft device for preventing the theft of a vehicle by comparing the information indicated as a code provided on a key and the information memorized in a vehicle.

### BACKGROUND OF THE INVENTION

Immobilizer systems for starting the engine of a vehicle only when a unique code (i.e., reference code) pre-registered on the vehicle and an ID code (unique code) output from an ignition key are identical, when the ignition key including a communication function with the vehicle is inserted to an ignition key cylinder (hereinafter referred as key cylinder), are known. For example, a system such as that explained above is described in Japanese Patent No. 2915299. The system described in Japanese Patent No. 2915299 prevents the vehicle from being stolen by starting the engine without authorization. With the system described in Japanese Patent No. 2915299, the engine cannot start if the unique code sent from the ignition key cannot be read by the vehicle or in case the reference code memorized by the vehicle and the ID code sent from the ignition key are not identical. Thus, the vehicle is prevented from being stolen.

Another immobilizer system is described in Celsior new model instruction manual August, 2000, Toyota Motor Corporation P. 3-264-269. With the system described in the Celsior new model instruction manual, the ignition key includes a communication function and the unique code sent from the ignition key is received by an antenna coil provided surrounding a key cylinder. On the vehicle side, the unique code of the ignition key inserted into the key cylinder is read, the identification of the code is judged, and the result of the code reading by an immobilizer control device is transmitted to the engine control device. In this case, the vehicle engine is started if the reference code memorized by the vehicle and the read unique code are identical to each other.

Notwithstanding, with the foregoing system the ignition key is required to have a communication function and the vehicle is required to include the antenna and the receiver to receive the unique code sent from the ignition key. Thus, the size of the ignition key, per se, is increased. In addition, because the unique code is transferred for identification by electromagnetic waves, the unique code sent to the vehicle is easier to copy.

A need thus exists for an anti-theft device whose unique code is more difficult to copy and wherein the size of the ignition key is not increased.

### SUMMARY OF THE INVENTION

In light of the foregoing, the present invention provides an anti-theft device for a vehicle which includes a code including unique information, and a reference code memorized in a vehicle. Starting of the engine is allowed when the unique code is identical to the reference code. The unique code is provided on an ignition key and the unique code includes portions including different reflective ratios when light is irradiated.

According to another aspect of the present invention, an anti-theft device for a vehicle includes a code including unique information, and a reference code memorized in a vehicle side. Starting of an engine is allowed when the unique code is identical to the reference code. The anti-theft device further includes a code reading means for reading the unique code by reflective light relative to an ignition key provided with the unique code, the code reading means provided at a key cylinder for starting the engine by insertion of the ignition key therein or near the key cylinder.

According to further aspect of the present invention, an anti-theft device for a vehicle includes a code including unique information, and a reference code memorized in a vehicle. Starting of an engine is allowed when the unique code is identical to the reference code. The anti-theft device further includes a code reader configured to read the unique code by reflective light relative to an ignition key provided with the unique code, the code reader provided at a key cylinder for starting the engine by insertion of the ignition key therein or near the key cylinder.

According to still further aspect of the present invention, an anti-theft method for a vehicle includes steps of detecting insertion of an ignition key, optically reading a code, identifying the read code and a reference code, and allowing or prohibiting a start of an engine based on the identifying step.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 is a front view showing a configuration of an ignition key for an anti-theft device according to an embodiment of the present invention.

FIG. 2 is a view, including a block diagram, of an entire construction of the anti-theft device according to the embodiment of the present invention.

FIG. 3 is a view showing a cross section taken on line III-III of FIG. 2.

FIG. 4 is a view showing a cross section taken on line IV-IV of FIG. 2.

FIG. 5 is a flow chart showing a transaction of a control device of FIG. 2.

FIG. 6 is a perspective view around a driving seat of a vehicle.

### DETAILED DESCRIPTION OF THE INVENTION

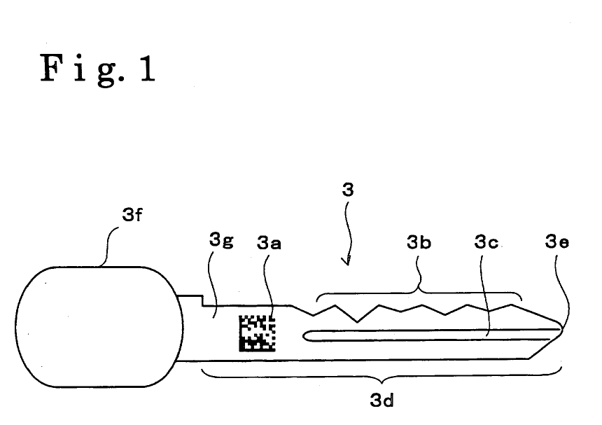

One embodiment of the present invention will be explained with reference to drawing figures shown in FIGS. 1-6.

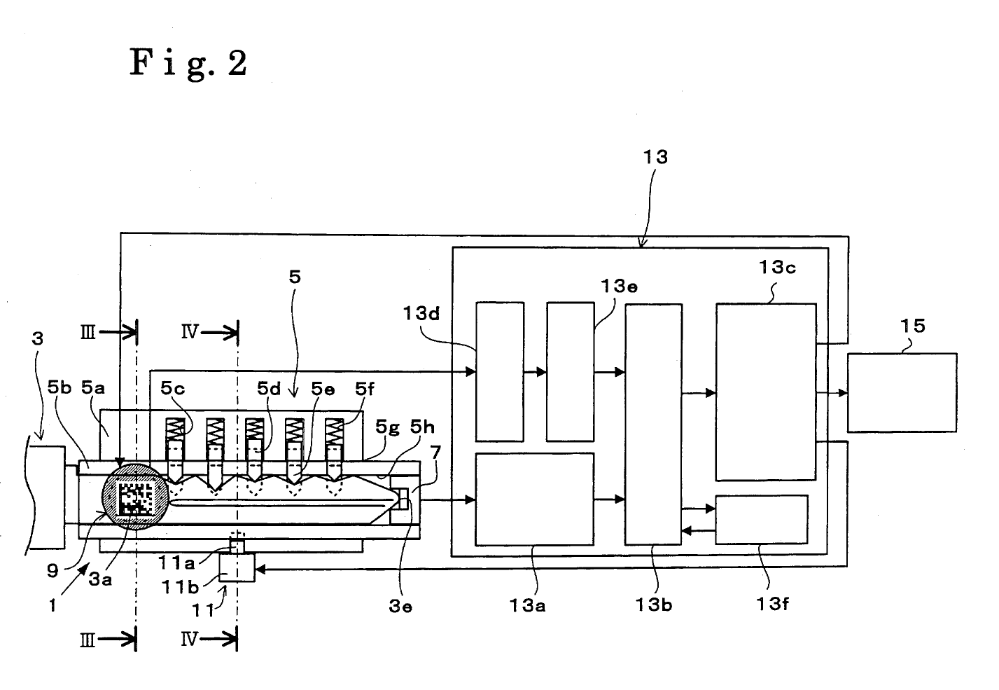

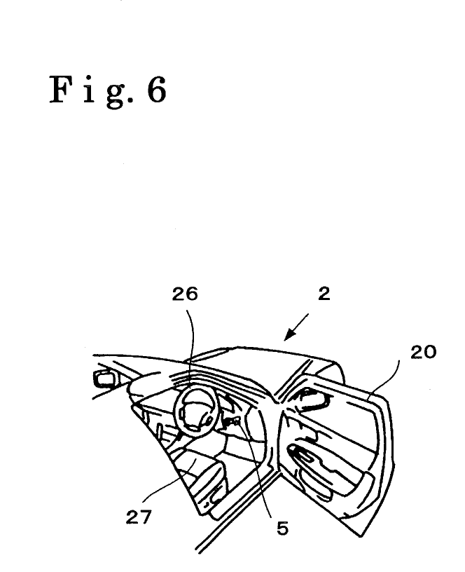

An anti-theft device 1 is applied to the vehicle in the embodiment. As shown in FIG. 6, a steering wheel 26 connected to steer front wheels is rotatably provided in front of a driver's seat 27 and a key cylinder 5 incorporated into the vehicle ignition so as to start an engine is provided behind the steering wheel 26. Referring to FIGS. 2-4, the key cylinder 5 is formed with a keyhole 5h in the center of a truncated conical surface. By inserting an ignition key 3 shown in FIG. 1 into the keyhole 5h and rotating the ignition key 3, the vehicle ignition assumes an ON state and a starter motor is driven to start the engine.

According to the embodiment, a unique code (hereinafter referred as code) 3a including the unique information is provided on the ignition key 3 configured to be inserted into the key cylinder 5. The unique information provided on the code 3a is read by a code reader 9 provided on the vehicle. The information read by the code reader 9 is compared with the information pre-memorized in a memory 13f of a controller 13 provided on the vehicle. In the embodiment of the present invention, the key cylinder 5 is configured to allow or prohibit the rotational operation of the ignition key 3 based on the code recognition by comparing and identifying the information from the code 3a.

The construction of the ignition key 3 of the anti-theft device 1 will be explained in detail with reference to FIG. 1. As shown in FIG. 1, the ignition key 3 includes a head portion 3f and a leg portion 3d. The leg portion 3d is extended from the head portion 3f. The head portion 3f is made of resin or metal and the leg portion 3d is made of metal having tensional strength. A key thread pattern 3b is formed on an external peripheral surface of the leg portion 3d, and a key groove 3c is formed in the center of the leg portion 3d, extending in parallel with the key thread pattern 3b in the longitudinal direction from a tip end of the leg portion 3d. A plane surface portion 3g is formed between the head portion 3f and the key groove 3c. The code 3a is preferably provided on the plane surface portion 3g.

In this embodiment, a two-dimensional code region of several millimeters on each side, and indicating the information with a matrix, is used for the code 3a. However, the code 3a is not limited to the aforementioned two-dimensional code, and one dimensional codes such as barcode, three-dimensional codes such as a code adding a color on two dimensional code, a code provided by varying a height in the thickness direction of the leg portion 3d, and multiple dimensional codes combining different dimensional code may be adopted. The portion providing the code 3a is not limited to the plane surface portion 3g and the code 3a may instead be provided on a portion of the ignition key 3 carried by the vehicle user.

The code 3a may be provided on the vehicle key 3 by etching and processing by a laser or the like on a predetermined face such as a surface. For example, the luster of the portion provided with the code 3a may be reduced by the surface processing relative to the plane surface portion 3g of the leg portion 3d having normal metal luster. More particularly, in case the code 3a is provided by laser processing, the portion irradiated with the laser is heated and ablated by the laser and oxidized to form dark cells. On the other hand, the portion which is not irradiated by the laser forms brighter cells because the luster of the metal surface is maintained. The cell indicates a smallest single division of the matrix in the two dimensional code. The code 3a including bright cells and dark cells includes the unique information of the ignition key 3, depending on the configuration patterns of each ignition key 3.

The size of the bright cells and dark cells on the code 3a is small compared to the size of the key thread pattern 3b. For example, the size of each cell may be 0.05-0.1 mm. Thus, even if the code 3a formed by the matrix is provided on the ignition key, per se, the decline in the mechanical strength of the ignition key is small enough to ignore. The degree of the anti-theft performance is increased because the duplication of the code is more difficult than the duplication of the key groove 3c and the key thread pattern 3b.

According to the embodiment of the present invention, the anti-theft device 1 includes the ignition key 3 carried by the user, the code reader 9 configured to read the unique information from the code 3a, the key cylinder 5 configured to start the engine upon the rotational operation of the ignition key 3, a lock mechanism including a lock pin 11a (operation restriction means) for restricting the rotational operation of the key cylinder 5 by the ignition key 3, an ignition key detection switch (detection means) 7 positioned to detect an insertion of the ignition key 3 into the key cylinder 5, the controller 13 including the memory (memory means) 13f memorizing the unique information of the reference code and configured to control the lock mechanism 11 by comparing the memorized information and the code on the ignition key 3 read by the operation of the code reader 9, and an engine control device 15 (reporting means) for starting the engine.

The anti-theft device 1 provided on the vehicle will be explained in more detail as follows. The construction of the key cylinder 5 will be explained referring to FIGS. 2-4. The key cylinder 5 includes an external cylinder 5a and an internal rotatable cylinder 5b for starting the engine by driving an engine starter motor upon the rotational operation of internal cylinder with the ignition key 3 inserted in the key cylinder 5. Plural lines (e.g., 5 lines in FIG. 2) of pin bores 5c are formed at a predetermined positions in parallel each other in the external cylinder S and the internal cylinder 5b. Each pin bore 5c of the key cylinder 5 includes a driver pin 5d and a tumbler pin 5e. The driver pin 5d has a pillar configuration and contacts an end of the coaxially provided tumbler pin 5e. A coil spring 5f biases the driver pin 5d in a radial inward direction coaxially to the driver pin 5d and is positioned in the pin bore 5c. Further, a portion of the tumbler pin 5e opposite to the driver pin 5d has a convex configuration and contacts the key thread pattern 5h.

With the key cylinder 5 of the foregoing construction, a surface provided between an internal periphery of the external cylinder 5a and an external periphery of the internal cylinder 5b defines a sliding line surface. The relationship between the driver pin 5d and the tumbler pin Se relative to the sliding line is as follows. The contacting surface between the driver pin 5d and the tumbler pin Se does not correspond to a sliding line surface 5g. When the convex tip end of the tumbler pin 5e projects from each opening portion of each pin bore 5c of the external cylinder 5a towards the internal peripheral side, the driver pin 5d radially traverses the sliding line surface 5g, the rotational operation of the internal cylinder 5b relative to the external cylinder 5a is restricted by the projection of the driver pin 5d, and the key cylinder 5 is locked not to rotate.

In this case, although the lengths of the driver pin 5d and the tumbler pin 5c positioned in the pin bore 5c as a pair are different depending on each pin bore 5e, the total length of a pair of the driver pin 5d and the tumbler pin 5e in each pin bore 5c is identical. For example, by inserting the ignition key 3 into the key bore 5h formed in the internal cylinder 5b and by rotating the ignition key 3, the convex end portion of the tumbler pin 5e projected towards the inside of the key bore 5h is pushed along the key thread pattern 3b to bias the tumbler pin 5e and the driver pin 5d in the radially outward direction in order to unlock the key cylinder 5. In this case, the tumbler pin 5e and the driver pin 5d are pushed radially outward while maintaining the tumbler pin 5e and the driver pin 5d in contact with the key thread 3b against the biasing force of the spring 5f. In this case, the contacting surface between the tumbler pin 5e and the driver pin 5d corresponds to the sliding line surface 5g.

Thus, the driver pin 5d contacting the tumbler pin 5e by the projection of the driver pin 5d towards the internal cylinder 5b is pushed into the pin bore of the external cylinder to return to the sliding line surface corresponding to the rotational border between the external cylinder 5a and the internal cylinder 5b. Thereafter, the internal cylinder 5b becomes rotatable relative to the external cylinder 5a in the key cylinder 5, and the key cylinder 5 assumes an unlocked state in which the rotational operation by the ignition key 3 can be performed.

Although the driver pin 5d and the tumbler pin 5e move within the pin bore 5c, the driver pin 5d and the tumbler pin 5e cannot be removed from the key bore 5h.

In the non-limiting embodiment of the present invention, the bore of the internal cylinder 5b has a bottom. A key detection switch 7 for detecting the operation state of the ignition key 3 (e.g., a micro switch for detecting the operation state of the ignition key 3 and a pressure switch for detecting the insertion of the ignition key 3 by pressure change) is provided on the bottom of the internal cylinder 5b. The key detection switch 7 is not limited to the foregoing construction as long as the insertion of the ignition key 3 in the ignition key bore 5h can be detected and an ignition key detection sensor may be applied. The key detection switch 7 is pushed by the tip end portion 3e of the leg portion 3d of the ignition key 3 when the ignition key 3 is inserted into the keyhole 5h, to assume an ON state. When the ignition key 3 is removed from the keyhole 5h, the pushing by the tip end portion 3e is cancelled and the detection switch assumes an OFF state. The key detection switch 7 is electrically connected to a power source circuit 13a of the controller 13, and the detection signal indicating the ON state of the key detection switch 7 by the insertion of the ignition key 3 into the keyhole 5h is transmitted to the controller 13. Then, electric power is supplied to the controller 13, with the signal as a trigger to operate a CPU 13b provided in the controller.

The controller 13 having power supplied according to the command of the key detection switch 7 includes the electric power circuit 13a supplying a predetermined electric voltage (e.g., 5V) to the controller, an image transfer circuit 13d configured to transfer an analogue image signal detected from the code reader 9 for optically reading the code 3a, a decode circuit 13e configured to convert the binarized information from the image transfer circuit 13d into information including particular strings, the memory 1 3f memorizing the unique information on the code 3a, a CPU 13b configured to recognize the code by comparing the analyzed information from the decode circuit 13e and the information memorized in the memory 13f, and an output circuit 13c for outputting the comparison result of the code recognition. Further, with the construction shown in FIG. 2, the signal output from the output circuit 13c can be transmitted to the engine controller 15.

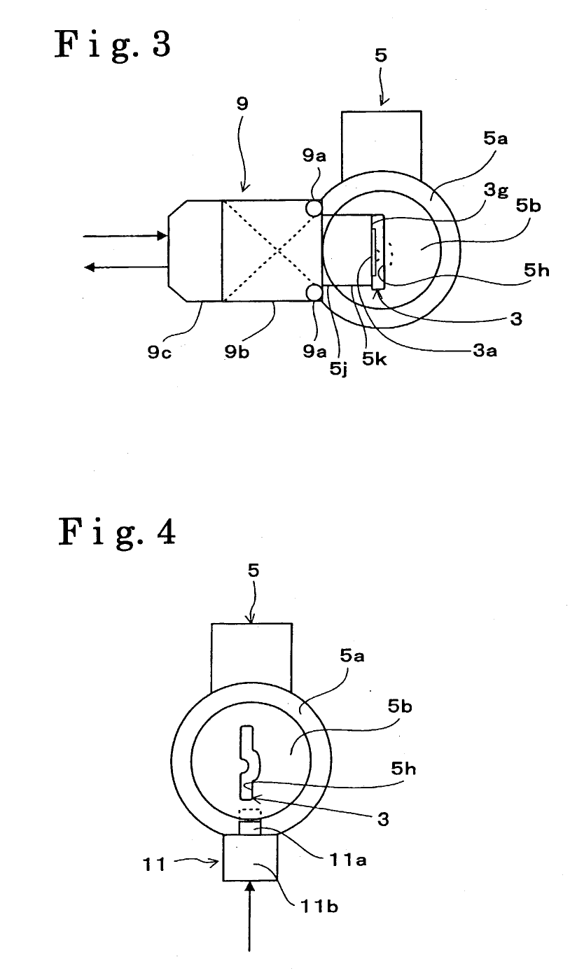

The code reader 9 will be explained with reference to FIGS. 3-4. As shown in FIG. 3, the code reader 9 is configured to recognize the insertion of the ignition key 3 into the keyhole 5h of the key cylinder 5 using the reflection of the light. The code reader 9 is directly connected to the external cylinder 5a or indirectly connected to the external cylinder 5a on a region proximate to the external cylinder 5a via an assembling bracket. In this case, as shown in FIG. 3, penetration bores 5j, 5k which are slightly larger than the code 3a are consecutively formed perpendicular to the code 3a. The image of code is captured by the code reader 9 via the penetration bores 5j, 5k formed on the external cylinder 5a and the internal cylinder 5b.

The code reader 9 includes a light source 9a configured to illuminate the plane surface portion 3g of the ignition key 3 provided with the code 3a, a diffusion portion 9b configured to internally diffuse the light generated by the light source 9a, and a camera portion 9c arranged to capture the image of the code 3a on a CCD element of a CCD camera using the reflective light irradiated on the code 3a.

As shown in FIG. 3, a pair of the light sources 9a is provided on internal top and bottom portions of the code reader 9. A light emitting diode (LED) with high luminance is used as the light source 9a. The light is generated from the light source 9a in an opposite direction from a surface to be read and provided with the code 3a, to prevent the direct irradiation of the light onto the code 3a.

The diffusion portion 9b has a hollow cylindrical configuration, and an internal surface of the diffusion portion 9b has a white color likely to reflect the light contacting the internal surface thereof.

The camera portion 9c images the diffuse light reflected from the code 3a as an image on the CCD element via the diffusion portion 9b and outputs an image analogue signal captured on the CCD element to the controller 13. The controller 13 compares the information captured by the camera portion 9a with the unique information memorized in the memory 13f, to restrict the operation of the key cylinder 5 by the lock mechanism (operation prohibition means) 11 against the rotational operation of the key cylinder 5 using the ignition key.

The construction of the lock mechanism 11 will be explained with reference to FIGS. 2 and 4. The lock mechanism 11 includes a lock pin 11 a positioned in the external cylinder 5a and the internal cylinder 5b configured to restrict or allow the rotation of the internal cylinder 5b relative to the external cylinder Sa by projecting and being retracted in the radial direction, and an electric actuator 11b fixed to the external cylinder 5a for actuating the lock pin 11a. Although a linear solenoid may be used as the electric actuator 11b, the construction of the electric actuator 1 l b is not limited and a construction in which the lock pin 11a is projected relative to the internal cylinder 5b by motor actuation or using a solenoid valve may instead be applied.

When an unlock signal (unlock allowance) is output from the controller 13 to the lock mechanism 11, the electromagnetic attraction force based on the unlock signal is applied to the electric actuator 11b to move the lock pin 11a to a position for canceling the rotational movement restriction of the internal cylinder 5b relative to the external cylinder 5a (position shown with a solid line of FIG. 4). On the other hand, the electric actuator 11b includes a spring configured to always bias the lock pin 11a in the inward radial direction, and the locked state is achieved when the unlock signal is not output from the controller 13. Under the locked state, the lock pin 11a is positioned at a position shown with dotted line of FIG. 4 by a biasing force of the spring, and the rotation of the internal cylinder 5b relative to the external cylinder 5a is restricted.

The operation will be explained as follows. When the ignition key 3 is not inserted into the key cylinder 5, the driver pins 5d and the tumbler pins 5e in the key cylinder are biased by the spring 5f to a position shown with dotted line of FIG. 2. Under this state, the driver pins 5d project into the internal cylinder 5b beyond the sliding line surface 5g to restrict the rotation of the internal cylinder 5b relative to the external cylinder 5a. The lock pin 11a of the lock mechanism 11 is biased inward by a spring (not shown) and projects into the internal cylinder as shown with the dotted line of FIG. 2 to restrict the rotation of the internal cylinder 5b relative to the external cylinder 5a. Thus, a double lock construction is applied.

When the ignition key 3 is inserted into the keyhole 5h of the internal cylinder 5b and when the leg portion 3d of the ignition key 3 reaches the sufficiently deep portion, the tip end portion 3e of the ignition key 3 pushes the key detection switch 7. The key detection switch 7 detects the condition to transmit the key detection signal to the controller 13. The controller 13, upon receiving the key detection signal, activates the power source circuit 13a to change the state from a sleep state having low electric power consumption to a normal actuation state (i.e., stand-by state for performing the code recognition).

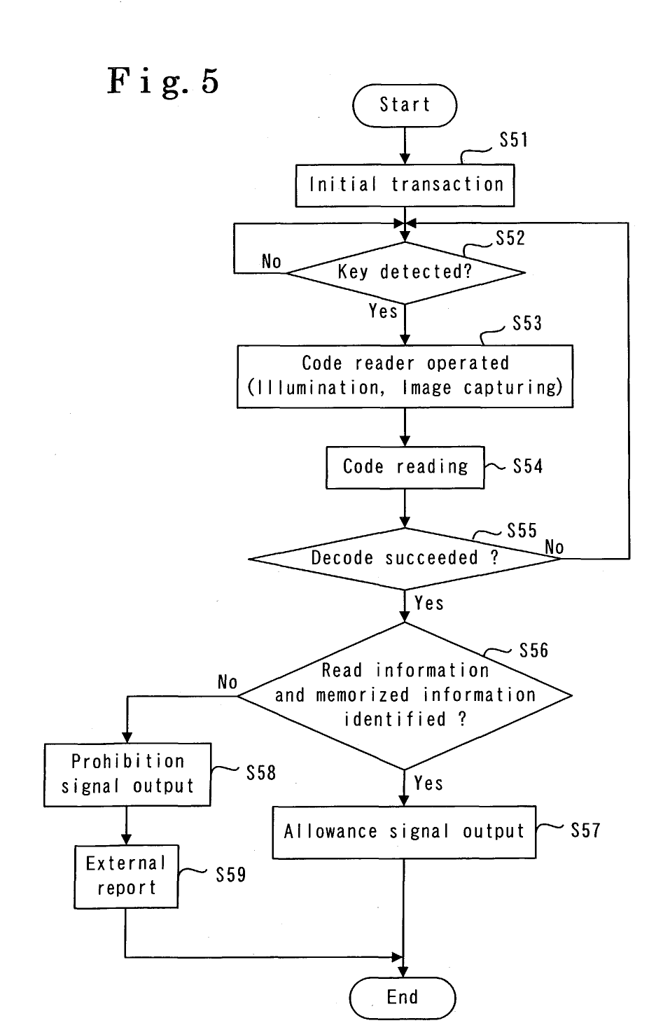

The transaction of a theft detection performed by the CPU 13b of the controller 13 will be explained with reference to a flowchart of FIG. 5. Steps of the program will be indicated with an S.

The controller 13 is supplied with a predetermined power (e.g., 12V) from an external battery and is actuated when the key is not operated under the low power consumption mode (i.e., sleep mode) for activating the bare minimum function. The controller 13 including a power line connected to the battery performs an initial operation at S51 when the predetermined power is supplied to the controller 13. With the initial operation, memory used for performing the anti-theft transaction is checked. In S51, an initial value is substituted for a necessary memory region and it is checked whether the anti-theft device 1 normally operates. Thereafter, the operation is held at S52 until the key detection switch 7 detects the key operation with the ignition key 3 or an operation similar to the key operation. When the ignition key 3 is inserted into the keyhole 5h or when an operation equivalent to the insertion of the ignition key 3 into the keyhole 5h (e.g., the improper operation of turning the key detection switch 7 ON by inserting a wire into the keyhole) is detected, the operation shown after S52 is carried out.

In other words, when the CPU 13b detects a rotational operation relative to the key cylinder 5 by the key detection switch 7, the power consumption mode is awakened from the sleep mode. Then, the controller enters the normal drive mode.

When the controller enters the normal drive mode, the operation advances to S53, the actuation of the code reader 9 is started and the CPU 13b outputs the drive signal for operating the code reader 9 via the output circuit 13c. Receiving the drive signal from the controller 13, the code reader 9 starts actuation. When the code reader 9 starts operating, the light source 9a is first illuminated for irradiating the surface to be read provided with the code 3a. In this case, the light generated by the light source 9a is diffused in the diffusion portion 9b and the light with the even optical power is irradiated onto the code 3a provided on the ignition key 3 via the external cylinder 5a and the penetration bores 5j, 5k of the internal cylinder 5b.

The code 3a includes the bright cells and dark cells having different reflective ratios. Because of the difference of the reflective ratios, the light entering the camera portion 9c after contacting the code 3a is different depending on the configuration of the code 3a. The code reader 9 includes the diffusion portion 9b in front of the camera portion 9c. Thus, the optical power of the reflective light with the high optical power reflected after contacting the code 3a is restrained at the diffusion portion 9b, even if the code 3a is provided on a leg portion 3d having a mirror surface in order to improve the appearance of the ignition key 3. Accordingly, the CCD element is not saturated when imaging the image on the CCD element of the CCD camera included in the camera portion 9c. With the foregoing construction, the code can be read by the code reader 9 even if the code 3a is provided on the leg portion 3d of an ignition key 3 having a mirror surface.

When the camera portion 9c captures the image of the code 3a in the foregoing manner, analogue image data is generated by the imaging to the CCD element and is transmitted to the image transaction circuit 13d. The signal is binarized at a predetermined level based on the analogue image signal in the image transaction circuit 13d and transmitted to the decode circuit 13e. The signal is converted into read information (strings) in the decode circuit 13e and transmitted to the CPU 13b.

When the read information read by the camera portion 9c is input into the CPU 13b, the code 3a is read at S54 and is memorized in the memory in the CPU. Thereafter, it is judged whether the CPU 13b has successfully performed decoding at S55. When the decoding is not achieved, it is judged that the normal decoding is not performed, control returns to Step S52 and the CPU 13b continues outputting the drive signal for driving the code reader 9 via the output circuit 1 3c to repeat the operation in Step S52.

On the other hand, when the read information of the code 3a is normally decoded at Step S55, it is judged at S56 whether the decoded read information and the memorized information memorized in the memory 13 f are identical. When the read information decoded after being read by the code reader 9 and the memorized information memorized in the memory 13f are not identical, the CPU 13b judges that the unlock operation has been performed by the operation of the key cylinder 5 by an ignition key 3 provided with a code 3a different from the legitimate code in the ignition key 3. It thereby outputs a lock signal with high potential to the lock mechanism 11 to the key cylinder 5 at S58. Thus, the lock pin 11a is projected into the internal cylinder 5b (i.e., locked state) to prohibit the rotational operation of the key cylinder 5 by the ignition key 3. Under this state, by judging an illegal operation of the key cylinder 5 without using the legitimate ignition key 3 (i.e., the ignition key having the reference code memorized in the memory 13f on the vehicle side), the controller 13 outputs a prohibition signal for prohibiting the starting of the engine to the engine controller 15 to entirely prohibit the engine control at S59 and the state is reported to the outside of the vehicle (i.e., an external report). The external report includes using a buzzer provided in the vehicle, informing the situation to the vehicle user using the navigation system which enables communication with the outside of the vehicle, and informing the situation to a supervisor for observing a system of plural vehicles in order to externally report the illegal conduct. In case the user has a contract with a security company for performing emergency reporting, the emergency may be instantly reported to the security company.

Because the controller 13 always observes whether the rotational operation of the key cylinder 5 is improperly performed without using the ignition key 3 including the legitimate unique code 3a, the anti-theft function is highly improved.

On the other hand, in case the CPU 13b judges whether the strings of the read information and the strings of the memorized information memorized in the memory and are identical, the CPU 13b outputs a low potential unlock signal to the lock mechanism 11 via the output circuit 13c at S57. When the CPU 13b outputs the unlock signal to the lock mechanism 11, the electric actuator 11b of the lock mechanism 11 operates and the linear solenoid is excited. With the magnetic attraction force of the linear solenoid, the lock pin 11a is retracted into the external cylinder from the state restricting the rotation of the internal cylinder 5b, to cancel the rotational restriction of the internal cylinder 5b relative to the external cylinder 5a to permit the engine to start with the ignition key 3. In this case, the engagement between the internal cylinder 5b and the external cylinder 5a is not cancelled unless the unlock signal with low potential is output to the lock mechanism 11.

After the rotational restriction of the internal cylinder 5b is canceled, the key cylinder 5 becomes rotatable by the unlock operation of the ignition key 3 inserted into the keyhole 5h to start the engine.

Although the code reader 9 and the lock mechanism 11 are provided on the key cylinder 5, the construction is not limited to the foregoing, and the code reader 9 and the lock mechanism 11 may be provided near the key cylinder 5. The code reader 9 and the key cylinder 5 may be formed as subassembly. In this case, the distance between the code 3a and the code reader 9 becomes shorter. It is preferable that the light irradiated relative to the code 3a from the diffusion portion 9b of the code reader 9 does not leak from the bores 5j, 5k and that the light from the outside is blocked. Thus, the effect of ambient light on the code reading operation can be restrained to make it easy to read the code 3a by the code reader 9, and thus the lock device having high code recognition with high a anti-theft function for preventing mal-operation is achieved.

According to an embodiment of the present invention, the unique code is provided on the ignition key and the unique code provided on the ignition key includes the different reflection rate when the light is irradiated on the unique code. Because reflective light is used, the communication function is not required on the ignition key and this improves the miniaturization of the ignition key. This provides an ignition key which is more portable. Because the fabrication of the unique code is easily performed compared to an electronic anti-theft device, the anti-theft performance is improved.

According to the embodiment of the present invention, the unique code provided on the ignition key can be read using reflective light because the code reader for reading the unique code by reflective light is provided. When the code reader is positioned close to the key cylinder or at the key cylinder for starting the engine, the unique code provided on the ignition key inserted into the key cylinder can be securely read by the code reader and the unique code can be identified. Thus, the allowance and prohibition for starting the engine can be performed based on the identification of the unique code.

In case the information read by the code reader and the information memorized in the memory are identical, the rotational operation of the key cylinder is allowed, and when both information are not identical to each other, the rotational operation of the key cylinder is prohibited. Thus, when the information read by the code reader and the information memorized in the memory are not identical to each other, the engine is not started and the start of the engine is prohibited by the double lock. Thus, the anti-theft performance is further improved.

When the detecting means for detecting the operation of the ignition key relative to the key cylinder is detected by the detection means, the code reader can be operated by the controller only when the operation of the ignition key relative to the key cylinder is detected and the detection means detects the insertion of the ignition key to the key cylinder.

Further, by performing the external reporting by the controller when the state that the information read by the code reader and the information memorized in the memory means are not identical is repeated for predetermined times, the anti-theft performance is further improved by reporting the emergency when the operation is repeated with the ignition key which does not have the unique code memorized in the memory means.

By controlling the start of the engine by the control means, because the anti-theft function can be added to the control means for performing the start of the engine and it is not necessary to have the independent control means for performing the anti-theft, the manufacturing cost can be reduced.

The principles, preferred embodiment and mode of operation of the present invention have been described in the foregoing specification. However, the invention which is intended to be protected is not to be construed as limited to the particular embodiment disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An anti-theft device for a vehicle, comprising:
an ignition key provided with a code including portions having different reflectivity to light;
a reference code memorized in the vehicle; and
a controller permitting a start of an engine when the code is judged to be identical with the reference code.

2. The anti-theft device for a vehicle according to claim 1, further comprising code reading means for reading the code by reflective light from the code of the ignition key, the code reading means being provided at a key cylinder for starting the engine by insertion of the ignition key therein or near the key cylinder.

3. The anti-theft device for a vehicle according to claim 2 further comprising:
operation prohibition means for prohibiting a rotational operation of the key cylinder; and
memory means for memorizing the code;
wherein the controller includes control means for prohibiting the rotational operation of the key cylinder when information read by the code reading means and information memorized in the memory means are not identical and for allowing the rotational operation of the key cylinder when the information read by the code reading means and the information memorized in the memory means are identical.

4. The anti-theft device for a vehicle according to claim 2 further comprising:
detection means for detecting an insertion operation of the key into the key cylinder;
wherein the reading of the code is performed by actuating the code reading means when the insertion operation is detected by the detection means.

5. The anti-theft device for a vehicle according to claim 2, wherein the controller outputs an external report when information read by the code reading means and information memorized in the memory means are not identical for a predetermined number of times.

6. The anti-theft device for a vehicle according to claim 2, wherein the controller controls the start of the engine.

7. An anti-theft device for a vehicle comprising:
an ignition key provided with a code including portions having different reflectivity to light;
a reference code memorized in the vehicle;
wherein a start of an engine is allowed when the code is identical with the reference code; and
a code reader configured to read the code by reflective light from the code of the ignition key, the code reader being provided at a key cylinder for starting the engine by insertion of the ignition key therein or near the key cylinder.

8. The anti-theft device for a vehicle according to claim 7 further comprising:
a lock mechanism for prohibiting a rotational operation of the key cylinder; and
a memory configured to memorize the code;
wherein the controller is configured to prohibit the rotational operation of the key cylinder when information read by the code reader and information memorized in the memory are not identical and to allow the rotational operation of the key cylinder when the information read by the code reader and the information memorized in the memory are identical.

9. The anti-theft device for a vehicle according to claim 7 further comprising:
a key detection switch for detecting an insertion of the key into the key cylinder; wherein the reading of the code is performed by actuating the code reader when the insertion operation is detected by the key detection switch.

10. The anti-theft device for a vehicle according to claim 7, wherein the controller outputs an external report when information read by the coder reader and information memorized in the memory are not identical for a predetermined number of times.

11. The anti-theft device for a vehicle according to claim 7, wherein the controller controls the start of the engine.

12. A method for anti-theft for a vehicle, comprising steps of:
detecting insertion of an ignition key;
optically reading a code;
comparing the read code and a reference code; and
selectively allowing or prohibiting a start of an engine based upon the comparison.

13. The method for anti-theft for the vehicle according to claim 12, wherein an emergency is reported to an outside when a state of prohibiting the start of the engine is repeated for a predetermined number of times.

14. The method for anti-theft for the vehicle according to claim 12, wherein the step of optically reading the code includes illuminating and capturing an image of the code.
